(19) United States
(12) Patent Application Publication
(10) Pub. No.: US 2023/0156007 A1
(43) Pub. Date: May 18, 2023

(54) COMMUNICATION MANAGEMENT APPARATUS, COMMUNICATION SYSTEM, COMMUNICATION MANAGEMENT METHOD, AND COMPUTER READABLE MEDIUM

(71) Applicant: NEC Corporation, Minato-ku, Tokyo (JP)

(72) Inventor: Tsukasa KOBAYASHI, Tokyo (JP)

(73) Assignee: NEC Corporation, Minato-ku, Tokyo (JP)

(21) Appl. No.: 18/009,847

(22) PCT Filed: Jun. 18, 2020
(86) PCT No.: PCT/JP2020/023931

§ 371 Date: Dec. 12, 2022

(51) Int. Cl. H04L 9/40

(52) U.S. Cl. CPC H04L 63/101; H04L 12/66

(57) ABSTRACT

A communication management apparatus includes: a template generation unit configured to generate a template including identification information of a packet for transferring data supplied from a device; a log reception unit configured to receive, from a relay apparatus configured to transfer data by a packet, log information, the data being supplied from a device provided in the communication system; an allowed list generation unit configured to generate an allowed list when the log information conforms to the template, a condition of a packet under which the transfer of the data is permitted being described in the allowed list; a determination support unit configured to determine, when the log information does not conform to the template, whether or not to register the identification information of the packet related to the log information in the list; and a transmission unit configured to transmit the-allowed list to the relay apparatus.

### TECHNICAL FIELD

The present disclosure relates to a communication management apparatus, a communication system, a communication management method, and a computer readable medium.

### BACKGROUND ART

In an Internet of Things (IoT) system composed of IoT devices, a communication apparatus that generates a list (an allowed list) used to determine whether or not to permit communication by a packet is known. For example, Patent Literature 1 discloses that a gateway generates an allowed list when the gateway is set to a learning mode.

### CITATION LIST

### Patent Literature

Patent Literature 1: Japanese Unexamined Patent Application Publication No. 2019-68119

### SUMMARY OF INVENTION

### Technical Problem

However, in the above-described method disclosed in Patent Literature 1, there is a problem that when the gateway in the learning mode acquires, from a device, an unknown or an unauthorized packet that is not expected by an administrator, the gateway generates an allowed list that includes these packets.

In view of the problem described above, an object of the present disclosure is to provide a communication management apparatus, a communication system, a communication management method, and a computer readable medium that are capable of avoiding an erroneous registration of an unknown or an unauthorized packet in an allowed list.

### Solution to Problem

A communication management apparatus according to one example aspect of the present disclosure is a communication management apparatus provided in a communication system. The communication management apparatus includes: a template generation unit configured to generate a template including identification information of a packet for transferring data supplied from a predetermined device based on design information of the communication system; a log reception unit configured to receive, from a relay apparatus configured to transfer data by a packet, log information about the transfer of the data by the packet, the data being supplied from a device provided in the communication system; an allowed list generation unit configured to generate an allowed list based on the log information when the log information conforms to the template, a condition of a packet under which the transfer of the data by the relay apparatus is permitted being described in the allowed list; a determination support unit configured to determine, when the log information does not conform to the template, whether or not to register the identification information of the packet related to the log information in the allowed list based on information about whether or not the log information can be registered; and a transmission unit configured to transmit the generated allowed list to the relay apparatus.

A communication system according to one example aspect of the present disclosure includes a plurality of devices, a plurality of relay apparatuses, and a communication management apparatus. The relay apparatus transfers, by a packet, data supplied from the device provided in the communication system. The communication management apparatus includes: a template generation unit configured to generate a template including identification information of a packet for transferring data supplied from a predetermined device based on design information of the communication system; a log reception unit configured to receive, from the relay apparatus, log information about the transfer of the data by the packet; an allowed list generation unit configured to generate an allowed list based on the log information when the log information conforms to the template, a condition of a packet under which the transfer of the data by the relay apparatus is permitted being described in the allowed list; a determination support unit configured to determine, when the log information does not conform to the template, whether or not to register the identification information of the packet related to the log information in the allowed list based on information about whether or not the log information can be registered; and a transmission unit configured to transmit the generated allowed list to the relay apparatus.

A communication management method according to one example aspect of the present disclosure includes: a template generation step of generating a template including identification information of a packet for transferring data supplied from a predetermined device based on design information of a communication system; a log reception step of receiving, from a relay apparatus configured to transfer data by a packet, log information about the transfer of the data by the packet, the data being supplied from a device provided in the communication system; an allowed list generation step of generating an allowed list based on the log information when the log information conforms to the template, a condition of a packet under which the transfer of the data by the relay apparatus is permitted being described in the allowed list; a determination support step of determining, when the log information does not conform to the template, whether or not to register the identification information of the packet related to the log information in the allowed list based on information about whether or not the log information can be registered; and a transmission step of transmitting the generated allowed list to the relay apparatus.

A non-transitory computer readable medium according to one example aspect of the present disclosure stores a communication management program. The communication management program causes a computer to execute: a template generation step of generating a template including identification information of a packet for transferring data supplied from a predetermined device based on design information of a communication system; a log reception step of receiving, from a relay apparatus configured to transfer data by a packet, log information about the transfer of the data by the packet, the data being supplied from the device; an allowed list generation step of generating an allowed list based on the log information when the log information conforms to the template, a condition of a packet under which the transfer of the data by the relay apparatus is permitted being described in the allowed list; a determination support step of determining, when the log information does not conform to the template, whether or not to register the identification information of the packet related to the log information in the allowed list based on information about whether or not the log information can be registered; and a transmission step of transmitting the generated allowed list to the relay apparatus.

### Advantageous Effects of Invention

According to the present disclosure, it is possible to provide a communication management apparatus, a communication system, a communication management method, and a computer readable medium that are capable of avoiding an erroneous registration of an unknown or an unauthorized packet in an allowed list.

### BRIEF DESCRIPTION OF DRAWINGS

FIG. 1 is a block diagram showing a configuration of a communication management apparatus according to a first example embodiment;

FIG. 2 is a schematic configuration diagram showing an example of a communication system according to a second example embodiment;

FIG. 3 is a block diagram showing an example of a configuration of a communication management apparatus according to the second example embodiment;

FIG. 4 is a diagram showing an example of a data structure of a template generated by a template generation unit according to the second example embodiment;

FIG. 5 is a diagram showing an example of a data structure of log information received by a log reception unit according to the second example embodiment;

FIG. 6 is a sequence diagram showing an example of operations performed by the communication system according to the second example embodiment;

FIG. 7 is a sequence diagram showing an example of the operations performed by the communication system according to the second example embodiment;

FIG. 8 is a diagram showing an example of a data structure of an allowed list generated by an allowed list generation unit according to the second example embodiment;

FIG. 9 is a diagram for explaining processing performed by the communication management apparatus according to the second example embodiment when log information does not conform to a template;

FIG. 10 is a diagram for explaining the processing performed by the communication management apparatus according to the second example embodiment when the log information does not conform to the template;

FIG. 11 is a block diagram showing an example of a configuration of a communication management apparatus according to a third example embodiment;

FIG. 12 is a sequence diagram showing an example of operations performed by a communication system according to the third example embodiment; and

FIG. 13 is a diagram for explaining processing for adding a template performed by the communication management apparatus according to third example embodiment.

### EXAMPLE EMBODIMENT

The present disclosure will be described hereinafter with reference to example embodiments. However, the following example embodiments are not intended to limit the scope of the disclosure according to the claims. Further, all the components described in the example embodiments are not necessarily indispensable as means for solving the problem. The same elements are denoted by the same reference symbols throughout the drawings, and redundant descriptions are omitted as necessary.

### First Example Embodiment

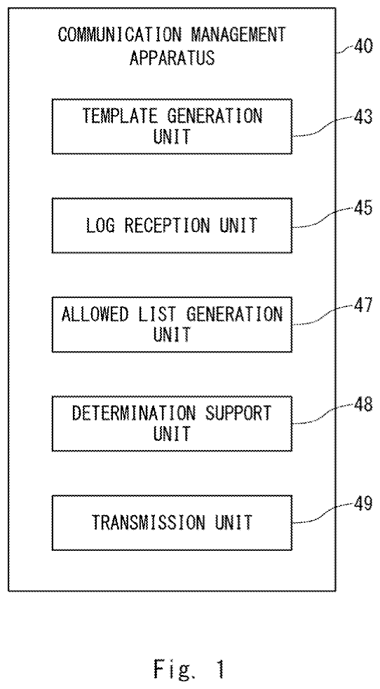

FIG. 1 is a block diagram showing a configuration of a communication management apparatus 40 according to a first example embodiment. The communication management apparatus 40, which is provided in a communication system, includes a template generation unit 43, a log reception unit 45, an allowed list generation unit 47, a determination support unit 48, and a transmission unit 49.

The template generation unit 43 generates a template including identification information of a packet for transferring data supplied from a predetermined device based on design information of the communication system.

The log reception unit 45 receives log information about a transfer of data by a packet from a relay apparatus. The relay apparatus is an apparatus that transfers data supplied from a device provided in the communication system by a packet.

The allowed list generation unit 47 generates an allowed list (a whitelist) based on the log information when the log information conforms to the template. The allowed list is a list in which conditions of a packet under which the transfer of the data by the relay apparatus is permitted are described.

The determination support unit 48 determines, when the log information does not conform to the template, whether or not to register the identification information of the packet related to the log information in the allowed list based on information about whether or not the log information can be registered.

The transmission unit 49 transmits the generated allowed list to the relay apparatus.

As described above, according to the first example embodiment, when log information about a packet related to a transfer of data does not conform to the template that is expected and prepared in advance, the communication management apparatus 40 determines whether or not to register the log information in the allowed list based on information about whether or not the log information can be registered. Therefore, the communication management apparatus 40 can avoid an erroneous registration of an unknown or an unauthorized packet, which is not expected in advance, in the allowed list, and can register a packet in the allowed list only when it is determined that it is necessary to register it.

### Second Example Embodiment

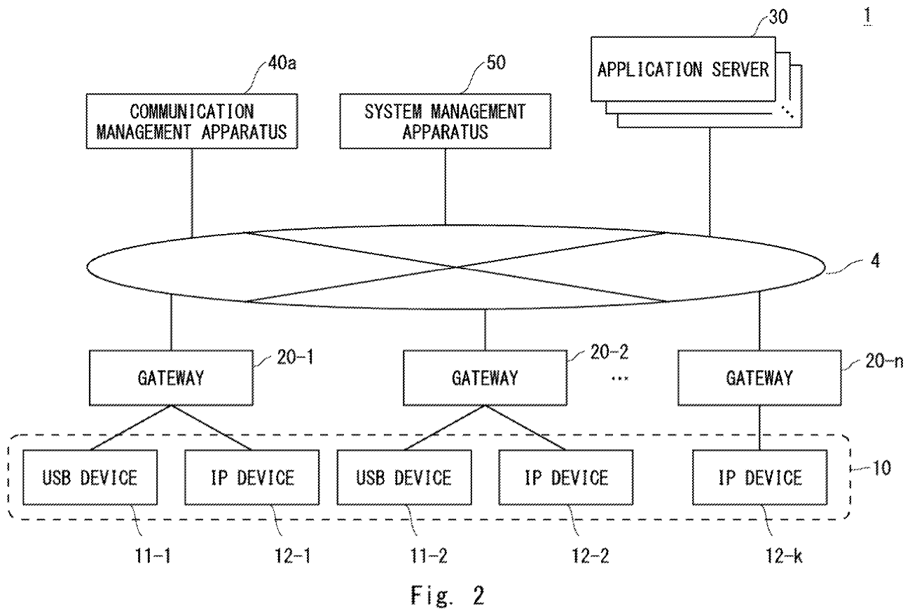

Next, a second example embodiment of the present disclosure will be described with reference to FIGS. 2 to 10. FIG. 2 is a schematic configuration diagram showing an example of a communication system 1 to which a communication management apparatus 40a according to the second example embodiment can be applied.

The communication system 1 is a system that exchanges data between a sensor, a camera, or the like and an application server via a network, and for example, is an IoT system. The communication system 1 includes a device 10, gateways 20-1, 20-2, . . . , and 20-n, an application server 30, the communication management apparatus 40a, and a system management apparatus 50. In the following description, the gateways 20-1, 20-2, . . . , and 20-n may be simply referred to as a gateway 20 when they are not distinguished from each other. In FIG. 2, the number of gateways 20 is set to be three or larger. However, the present disclosure is not limited thereto and the number of gateways 20 may instead be one or two.

Note that the gateway 20, the application server 30, the communication management apparatus 40a, and the system management apparatus 50 are connected to a network 4 wirelessly or by wire.

The network 4 is composed of the Internet or a combination of the Internet and various types of networks such as a wide area network (WAN) or a local area network (LAN).

The device 10 is a device such as a sensor or a camera that acquires information about a state of an object to be monitored. The device 10 outputs the acquired information as data such as sensing data or image data and supplies it to the gateway 20.

The device 10 includes, as an example, at least one of a USB device 11 and an IP device 12.

The USB device 11 is connected to the gateway 20 via a Universal Serial Bus (USB) interface (USB IF) so that it can be attached to and detached from the gateway 20 and outputs data to the gateway 20 via the USB IF. The IP device 12 is a device having an Internet Protocol (IP) address.

The IP device 12 is connected to the gateway 20 via a wireless LAN communication interface (a wireless LAN IF) so that it can communicate with the gateway 20 and transmits data to the gateway 20 via the wireless LAN IF.

In the following description, when a state in which data can be exchanged between the device 10 and the gateway 20 is referred to, this state is referred to as a state in which the device 10 is “device-connected” to the gateway 20, and the interface between the device 10 and the gateway 20 is referred to as a “device connection IF”.

In FIG. 2, as an example, the gateway 20-1 is device-connected to a USB device 11-1 and an IP device 12-1. Further, the gateway 20-2 is device-connected to a USB device 11-2 and an IP device 12-2. Further, the gateway 20-n is device-connected to an IP device 12-k.

Note that the device 10 is not limited to the USB device 11 and the IP device 12. The device 10 may include a near field communication-enabled device that is device-connected to the gateway 20 via a Bluetooth (registered trademark) Low Energy (BLE) interface or the like, or a device that is device-connected to the gateway 20 via any other device connection IF.

The gateway 20 is a computer that functions as a relay apparatus that transfers data supplied from the device 10 to the application server 30 by a packet. Further, the gateway 20 forwards a packet received from the application server 30 to the device 10. In the following description, “forwarding a packet” may include converting data supplied from the device 10 into a packet of a predetermined protocol and format and sending it to a destination in addition to forwarding a packet received from the device 10 or the application server 30 to the destination. The protocol and format are defined for each application (process) inside the gateway 20, which application corresponds to the device 10 that is device-connected to the gateway 20. That is, the gateway 20 may relay communication between the device 10 and the application server 30, or the process inside the gateway 20 may communicate with the corresponding application server 30.

Note that the gateway 20 may be provided with an Ethernet (registered trademark) communication interface (IF) and at least one type of a device connection IF selected from among a wireless LAN IF, a USB IF, and any other device connection IF.

Note that the gateway 20 is set to an operation mode or a learning mode.

When the gateway 20 is set to the operation mode, the gateway 20 determines, by using an allowed list, which is a list in which conditions of a packet under which transfer of data is permitted are described, whether or not a packet related to data to be transferred conforms to the allowed list. Then the gateway 20 transfers only the packet that conforms to the allowed list and discards packets other than this packet.

When the gateway 20 is set to the learning mode, the gateway 20 transfers a packet related to data to be transferred to the destination application server 30 or the destination device 10. Then the gateway 20 transmits information for generating (learning) an allowed list for that gateway 20 to the communication management apparatus 40a. In the second example embodiment, the information for learning an allowed list is log information about transfer of data by a packet, that is, log information of a packet transmitted by the gateway 20 in order to transfer data.

The application server 30 is a computer such as a server computer that processes data acquired from the device 10 via the gateway 20. The application server 30 may be provided so that it corresponds to the type of the device 10.

The communication management apparatus 40a is a computer, such as a server computer, which generates an allowed list of the gateway 20. The communication management apparatus 40a generates, based on information received from the gateway 20 that is set to the learning mode, an allowed list corresponding to this gateway 20, and distributes the generated allowed list to this gateway 20.

Further, the communication management apparatus 40a generates an allowed list under predetermined conditions based on information about whether or not registration can be performed received from the system management apparatus 50. The information about whether or not registration can be performed is information indicating whether or not a record based on a packet related to data to be transferred may be registered in the allowed list.

The system management apparatus 50 is a computer used by a system administrator who manages the communication system 1. The system management apparatus 50 transmits information about whether or not registration can be performed set by the system administrator to the communication management apparatus 40a. Note that the system management apparatus 50 may be incorporated into the communication management apparatus 40.

In this example, the communication system 1 is intended for a system, such as an IoT system, in which a system design is performed in advance. Such a system is designed so that communication and device connection methods used by the system fit into a specific pattern. Therefore, design information is prepared in advance, the design information including information about communication among the device 10, the application server 30, and the gateway 20 that can be used in the communication system 1, and a device connection of this device 10. Note that, in an IT system, for example, since a wide variety of communications are performed through a web browser on a user's computer to the Internet, it is difficult to perform a design in advance and to grasp communication in advance.

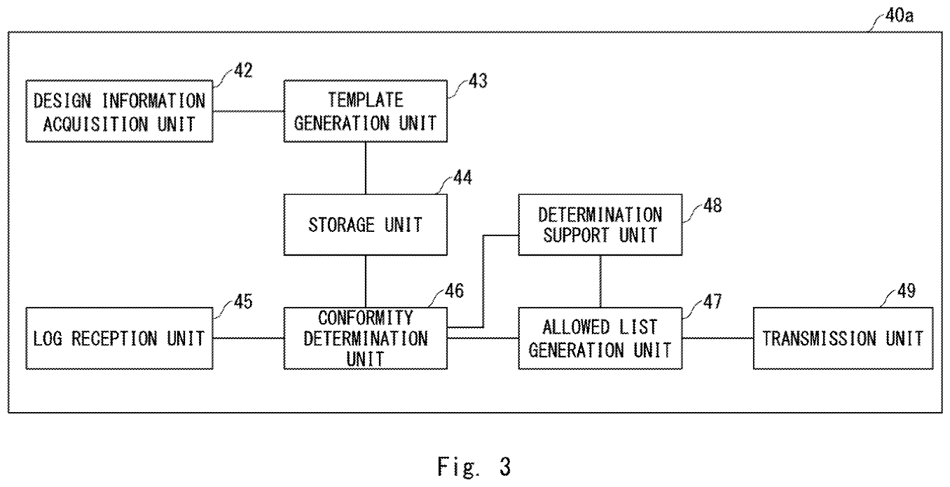

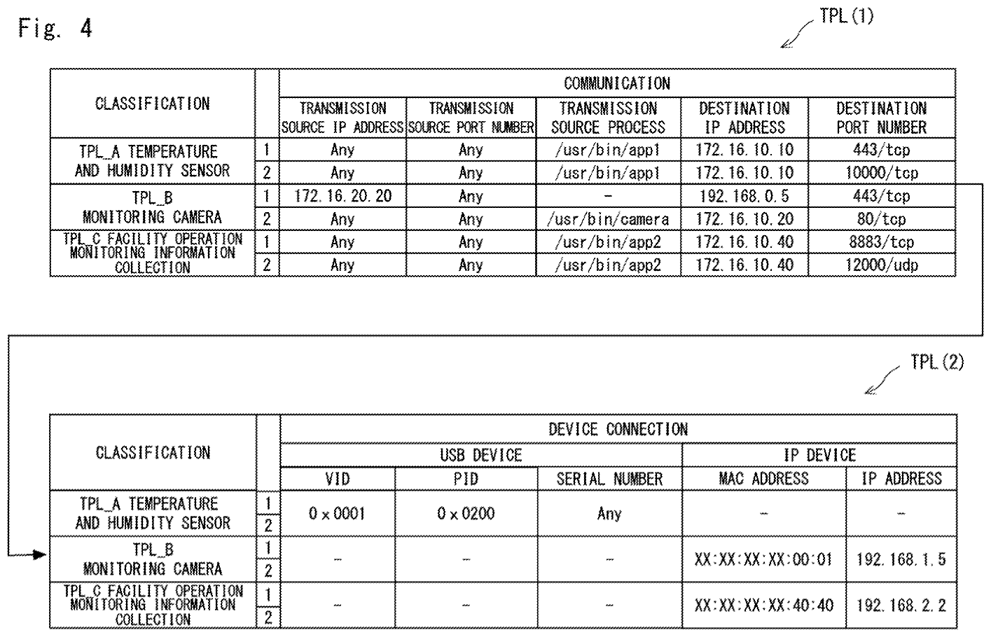

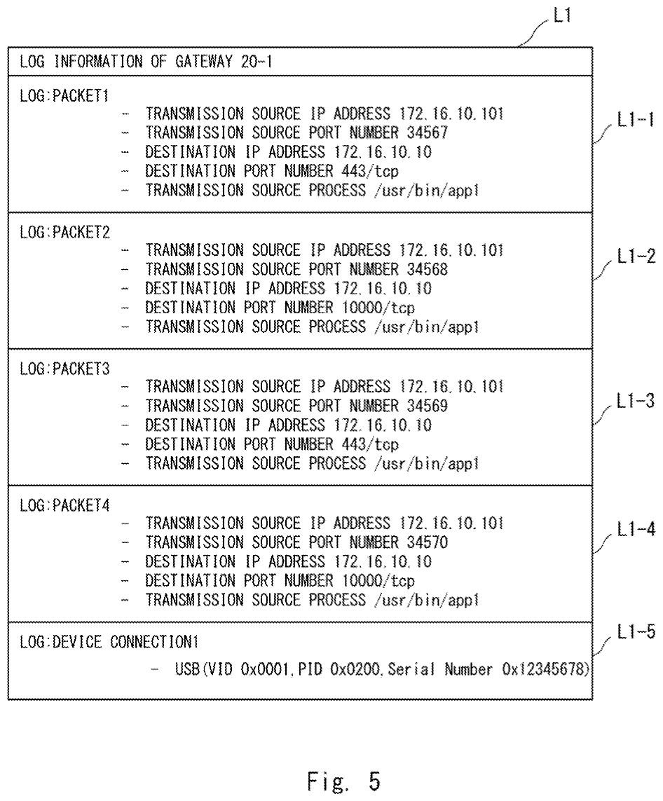

Next, using FIG. 3, a configuration of the communication management apparatus 40a according to the second example embodiment will be described with reference to FIGS. 4 and 5. FIG. 3 is a block diagram showing an example of a configuration of the communication management apparatus 40a according to the second example embodiment. The communication management apparatus 40a includes a design information acquisition unit 42, the template generation unit 43, a storage unit 44, the log reception unit 45, a conformity determination unit 46, the allowed list generation unit 47, the determination support unit 48, and the transmission unit 49.

The design information acquisition unit 42 acquires design information related to that device 10 in the communication system 1 for each type of the device 10. Note that the design information includes information about communication among the device 10, the application server 30, and the gateway 20 that can be used in the communication system 1 and a device connection of this device 10. Then the design information acquisition unit 42 supplies the acquired design information to the template generation unit 43.

The template generation unit 43 generates, for each type of the device 10 which is predetermined as the device 10 that can be used in the communication system 1, a template based on design information related to the device 10. The template includes identification information of a packet for transferring data supplied from the device 10. Note that the identification information includes at least one of header information of the packet, transmission source process information, and device connection information between the gateway 20 and the device 10.

FIG. 4 is a diagram showing an example of a data structure of a template generated by the template generation unit 43 according to the second example embodiment. The template includes a template TPL(1) for identification information about communication and a template TPL(2) for identification information about a device connection.

In the example shown in FIG. 4, the template TPL(1) includes items of a transmission source IP address, a transmission source port number, a transmission source process name, a destination IP address, and a destination port number as the identification information about communication. Note that the identification information about communication is not limited to the above-described items, and may include items corresponding to a destination domain name, a user name of the transmission source process, and a destination Media Access Control (MAC) address. Note that although the transmission source process name is a process path including the process name, it may instead be simply the process name. The transmission source process name, the domain name, and the user name of the transmission source process are specified using the IP address included in the header information.

The template TPL(2) includes, as the identification information about a device connection, items of a Vendor ID (VID), a Product ID (PID), and a serial number when the device 10 is the USB device 11, while it includes items of a MAC address and an IP address when the device 10 is the IP device 12.

The template TPL is generated for each type of the device 10. In this example, the device 10 that can be used in the communication system 1 includes a temperature and humidity sensor, a monitoring camera, and a facility operation monitoring information collection device. For example, a TPL_A, which is the first record of the template TPL, is a template related to the temperature and humidity sensor. As shown in the TPL_A, the temperature and humidity sensor is the USB device 11 in which the VID is “0x0001” and the PID is “0x0230”. The data related to the temperature and humidity sensor is designed so as to be processed by a process “usr/bin/appl” in the gateway 20 and forwarded to a destination port number “443/tcp” or “10000/tcp” and a destination IP address “172.16.10.10”. The transmission source address, the transmission source port number, and the serial number, which are items of the TPL_A, are set to “Any”, indicating that they are optional.

Further, a TPL_B, which is the second record of the template TPL, is a record related to the monitoring camera. As shown in TPL_B, the monitoring camera is the IP device 12 in which the MAC address is “XX:XX:XX:XX:00:01” and the IP address is “192.168.1.5”, and data related to the monitoring camera is designed so as to be able to be transferred by two different methods. The first method is a method of transferring packets received from a transmission source IP address “172.16.20.20” to a destination IP address “192.168.0.5”. Further, the second method is a method of processing data acquired from the monitoring camera by a process “usr/bin/camera” in the gateway 20 and transferring it to a destination port number “80tcp” and a destination IP address “172.16.10.20”.

The storage unit 44 is a storage medium for storing a template generated by the template generation unit 43.

The log reception unit 45 receives log information about packet forwarding from each of a plurality of gateways 20. FIG. 5 is a diagram showing an example of a data structure of log information received by the log reception unit 45 according to the second example embodiment. FIG. 5 shows log information L1 of the gateway 20-1. As an example, the log information L1 includes five logs L1-1 to L1-5. Each of the logs L1-1 to L1-4 includes identification information of forwarded packets 1 to 4. Specifically, each of these logs includes a transmission source IP address, a transmission source port number, a transmission destination IP address, a destination port number, and transmission source process name. The log L1-5 includes identification information about a device connection. Specifically, it includes a VID, a PID, and a serial number when the device 10 is the USB device 11, while it includes a MAC address and an IP address when the device 10 is the IP device 12.

In this example, the device 10 is the USB device 11 in which the VID is “0x0001” and the PID is “0x0200”, the destination port number of the packet related to the transfer of the data is “443/tcp” or “10000/tcp”, and the transmission source process is “usr/bin/appl”. Therefore, the device 10 is the temperature and humidity sensor specified in the TPL_A shown in FIG. 4. Note that the transmission source IP address “172.16.10.101” recorded in the logs L1-1 to L1-4 is the IP address of the gateway 20-1.

The log reception unit 45 supplies the received log information to the conformity determination unit 46.

The conformity determination unit 46 determines whether or not the received log information conforms to the template TPL. That is, the conformity determination unit 46 determines whether or not the packet transferred by the gateway 20 conforms to one of the templates TPL stored in the storage unit 44. The conformity determination unit 46 supplies a result of the determination to the allowed list generation unit 47 or the determination support unit 48.

Note that the case in which the transferred packet does not conform to the template TPL includes a case in which the transferred packet is a packet related to communication that does not occur during a normal operation, such as a packet for reporting an error at the time of failure. It also includes a case in which the forwarded packet is a packet related to unintended communication, such as a packet related to communication in which a forwarded packet has been infected with malware to exploit information. It also includes a case in which the transferred packet is a packet related to communication that cannot be templated since design information is not available in advance, such as communication using upgraded software or software made by another company.

For each of the plurality of gateways 20, the allowed list generation unit 47 registers, when log information received from the gateway 20 conforms to the template TPL, identification information of the packet related to the log information in the allowed list. By doing so, the allowed list generation unit 47 generates the allowed list for each of the plurality of gateways 20. The allowed list generation unit 47 supplies the generated allowed list to the transmission unit 49.

For each of the plurality of gateways 20, the determination support unit 48 acquires, when log information received from the gateway 20 does not conform to the template, information about whether or not the log information can be registered. Then the determination support unit 48 determines whether or not to register identification information of the packet related to the log information in the allowed list based on the information about whether or not the log information can be registered. The determination support unit 48 supplies a result of the determination to the allowed list generation unit 47. Then the allowed list generation unit 47 registers, in the allowed list, identification information of the packet related to the log information which it is determined can be registered.

The transmission unit 49 transmits, to each of the plurality of gateways 20, an allowed list corresponding to each of the plurality of gateways 20.

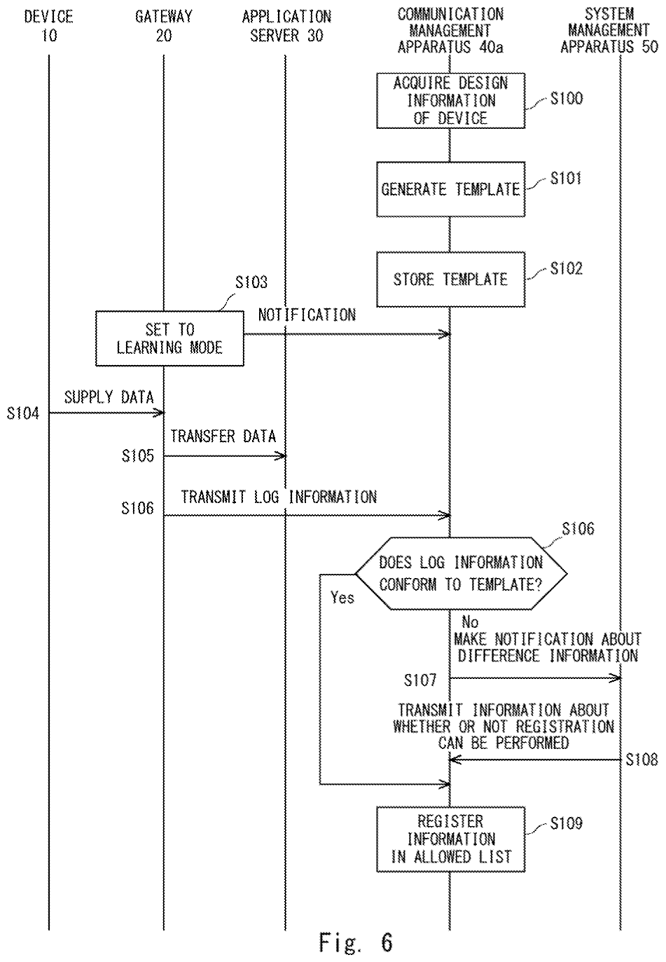

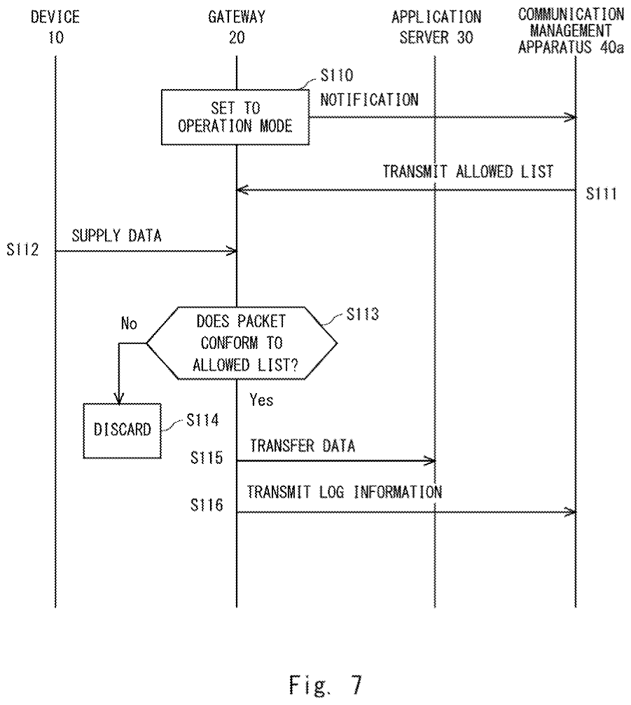

Each of FIGS. 6 and 7 is a sequence diagram showing an example of operations performed by the communication system 1 according to the second example embodiment. In FIGS. 6 and 7, for the sake of convenience of description, operations related to data communication from the device 10 to the application server 30 are shown, while operations related to data communication from the application server 30 to the device 10 are omitted.

First, the communication management apparatus 40a generates the template TPL in advance for each type of the device 10. Specifically, the design information acquisition unit 42 of the communication management apparatus 40a acquires design information of the device 10 that can be used in the communication system 1 (Step S100 in FIG. 6). Then the design information acquisition unit 42 supplies the design information to the template generation unit 43 of the communication management apparatus 40a.

Next, the template generation unit 43 generates the template TPL including identification information about communication and identification information about a device connection based on the design information of the device 10 (Step S101).

Next, the template generation unit 43 stores the template TPL in the storage unit 44 of the communication management apparatus 40a (Step S102).

Operations performed by the communication system 1 when the gateway 20 is set to the learning mode will be described below. In response to the gateway 20 being set to the learning mode, the gateway 20 notifies the communication management apparatus 40a about the start of the learning mode (Step S103). By doing the above, the communication management apparatus 40a starts processing for generating an allowed list.

Further, the device 10 connected to the gateway 20 supplies data which it holds to the gateway 20 (Step S104). Note that, when the device 10 is the USB device 11, the held data is output to the gateway 20 via the USB IF. At this time, the process inside the gateway 20 acquires the output data. Note that, in the process of the gateway 20, device connection information of the USB device 11 is acquired in response to the USB device 11 being inserted into the USB IF. Further, when the device 10 is the IP device 12, the held data is transmitted as a packet to the gateway 20 via the wireless LAN IF. The packet to be transmitted may include SYN and ACK packets of three-way handshake processing for establishing a connection between the device 10 and the application server 30. The gateway 20 acquires the transmission source IP address, the destination IP address, the transmission source port number, and the destination port number from header information of the packet. Then the gateway 20 acquires the transmission source process name from the destination IP address, the destination port number, and the protocol included in the header information.

The gateway 20 transfers the data acquired from the device 10 to the destination application server 30 (Step S105). Specifically, the gateway 20 converts data acquired from the USB device 11 or data related to the packet received from the IP device 12 into a packet of a predetermined protocol and format by the process inside the gateway 20, and transmits the converted packet to the destination application server 30. Alternatively, the gateway 20 forwards the packet received from the IP device 12 to the destination application server 30.

The gateway 20 transmits the log information generated by the transfer of the packet in Step S105 to the log reception unit 45 of the communication management apparatus 40a (Step S106). The log reception unit 45 supplies the received log information to the conformity determination unit 46.

The conformity determination unit 46 of the communication management apparatus 40a determines whether or not the received log information conforms to one of the templates TPL stored in the storage unit 44 (Step S106). For example, in the examples shown in FIGS. 4 and 5, the conformity determination unit 46 determines that the log information received from the gateway 20-1 conforms to the template TPL_A related to the temperature and humidity sensor. When there is a template TPL which conforms to the received log information (Yes in Step S106), the conformity determination unit 46 notifies the allowed list generation unit 47 that there is a template TPL which conforms to the log information and about the edge gateway number specifying the gateway 20. Then the allowed list generation unit 47 newly registers the identification information of the packet and the identification information about a device connection included in the received log information in the allowed list (Step S109). By doing so, the allowed list generation unit 47 generates the allowed list. Note that, when identification information similar to the identification information to be registered has already been registered in the allowed list, new registration of it may be omitted.

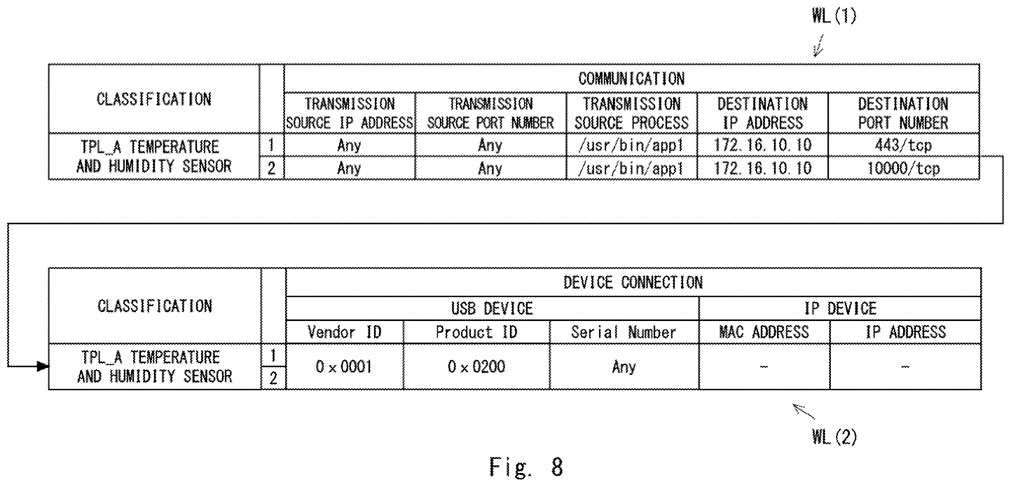

An allowed list generated by the allowed list generation unit 47 will be described below. FIG. 8 is a diagram showing an example of a data structure of an allowed list generated by the allowed list generation unit 47 according to the second example embodiment. In FIG. 8, as conditions under which a transfer of data by the gateway 20-1 is permitted, an allowed list WL(1) that specifies the condition regarding communication and an allowed list WL(2) that specifies the condition regarding a device connection are shown. Note that the allowed lists WL(1) and (2) shown in FIG. 8 have the same information as those of the templates TPL_A(1) and (2) related to the temperature and humidity sensor shown in FIG. 4.

Referring back to FIG. 6, when there is no template TPL which conforms to the received log information (No in Step S106), the determination support unit 48 notifies the system management apparatus 50 about difference information indicating that the log information does not conform to the template TPL (Step S107).

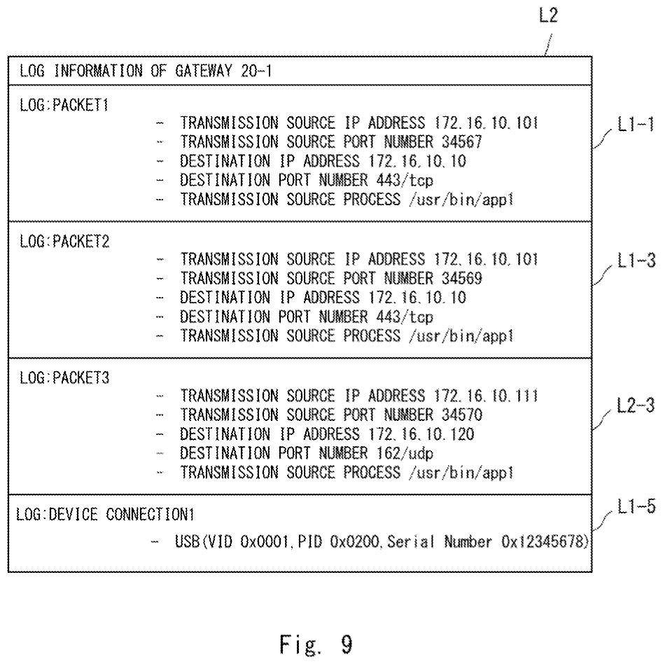

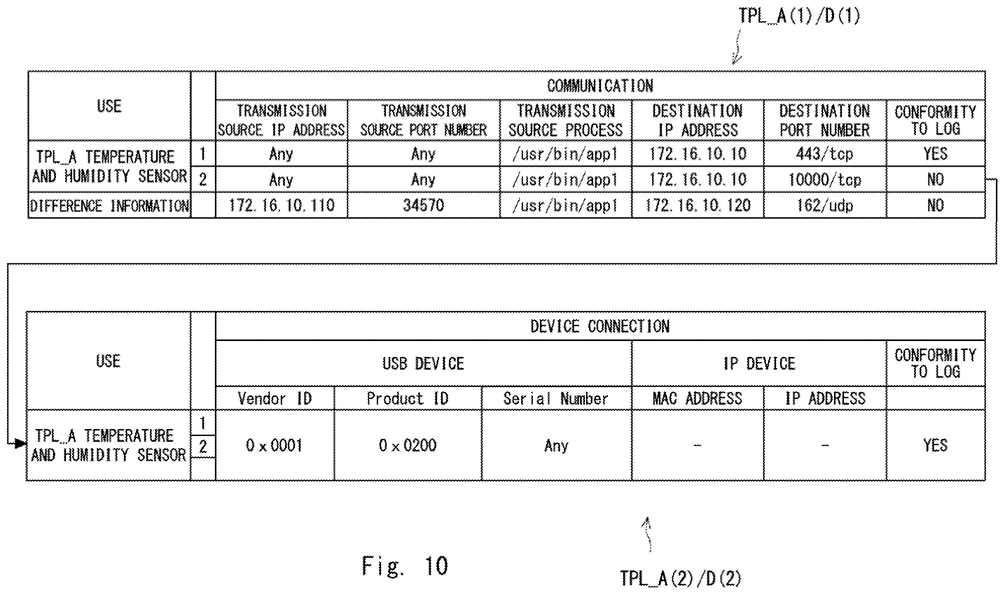

The difference information notified by the determination support unit 48 will be described below with reference to FIGS. 9 and 10. Each of FIGS. 9 and 10 is a diagram for explaining processing performed by the communication management apparatus 40a according to the second example embodiment when log information does not conform to the template. FIG. 9 shows log information L2 received from the gateway 20-1. Further, FIG. 10 shows templates TPL_A(1)/D(1) and TPL_A(2)/D(2) including difference information D(1) and difference information D(2) generated based on the log information L2.

As shown in FIG. 9, the log information L2 includes a log L2-3 in addition to the logs L1-1, L1-3, and L1-5 included in the log information L1 shown in FIG. 5. The various types of identification information pieces included in the logs L1-1, L1-3, and L1-5 conform to the template TPL_A, while identification information of the packet included in the log L2-3 does not conform to any template TPL. Therefore, the determination support unit 48 generates information in which identification information of the packet included in the log L2-3 which does not conform to any template TPL is added as difference information to the template TPL_A which conforms to the logs L1-1, L1-3, and L1-5 as shown in FIG. 10. Then the determination support unit 48 transmits the generated information to the system management apparatus 50. By the above operations, a system administrator may be prompted to make a determination.

Note that, when the system management apparatus 50 is incorporated into the communication management apparatus 40, the determination support unit 48 may notify the system administrator by displaying the generated information on a Web screen for management.

Referring back to FIG. 6 again, the system management apparatus 50 determines whether or not to register the identification information included in the log information in the allowed list based on the acquired difference information, and transmits information about whether or not registration can be performed, which indicates a result of the determination, to the determination support unit 48 of the communication management apparatus 40a (Step S108). The information about whether or not registration can be performed may be information input by a system administrator, which information is determined by the system administrator based on his/her knowledge, or may be information determined based on a predetermined determination criterion. Then the determination support unit 48 determines whether or not to register the identification information of the packet related to the log information in the allowed list in response to the acquisition of the information about whether or not registration can be performed from the system management apparatus 50. Then, only when registration can be performed, the determination support unit 48 notifies the allowed list generation unit 47 that registration can be performed and about the difference information, and proceeds the process to the above-described Step S109.

Next, operations performed by the communication system 1 when the gateway 20 is set to the operation mode will be described. In response to cancelling the learning mode of the gateway 20 and setting the gateway 20 to the operation mode, the gateway 20 notifies the communication management apparatus 40a about the end of the learning mode (Step S110 in FIG. 7). Then the transmission unit 49 of the communication management apparatus 40a transmits the generated allowed list to the gateway 20 corresponding to the edge gateway number (Step S111).

Then the device 10 supplies the held data to the gateway 20 in a manner similar to that by which it supplies the held data to the gateway 20 in Step S104 (Step S112).

The gateway 20 determines whether or not the packet related to the data acquired from the device 10 conforms to any record of the allowed list acquired from the communication management apparatus 40a (Step S113). At this time, the gateway 20 may set, as a determination target, a packet in which the data acquired from the USB device 11 or the IP device 12 is converted into a packet of a predetermined protocol and format by the process inside the gateway 20, or a packet received from the IP device 12.

When the gateway 20 determines that the packet conforms to any record in the allowed list (Yes in Step S113), it transfers the packet related to the data acquired from the device 10 to the destination application server 30 (Step S115). Then the gateway 20 transmits log information generated by the transfer of the packet in Step S115 to the communication management apparatus 40a (Step S116).

On the other hand, when the gateway 20 determines that the packet does not conform to any record in the allowed list (No in Step S113), it discards the packet (Step S114).

As described above, according to the second example embodiment, when log information about a packet related to a transfer of data does not conform to the template that is expected and prepared in advance, the communication management apparatus 40a determines whether or not to register the packet in the allowed list based on information about whether or not the log information can be registered. Therefore, the communication management apparatus 40a can avoid an erroneous registration of an unknown or an unauthorized packet, which is not expected in advance, in the allowed list, and can register a packet in the allowed list only when it is determined that it is necessary to register it.

Further, when log information about a packet related to a transfer of data does not conform to the template, the communication management apparatus 40a notifies the system management apparatus 50 about information indicating the log information does not conform to the template. Therefore, a system administrator can easily notice the presence of an unknown or an unauthorized packet, and the communication management apparatus 40a can receive an instruction from the system administrator on demand and reflect this instruction therein.

Further, since the communication management apparatus 40a executes, for the plurality of gateways 20, the above-described processing for generating an allowed list, it becomes easy to centrally manage the allowed lists on the communication system 1.

Note that, in the second example embodiment, it is assumed that the communication management apparatus 40a performs processing for generating an allowed list in a period during which the gateway 20 is set to the learning mode. However, the communication management apparatus 40a may perform processing for generating an additional allowed list based on log information after the learning mode of the gateway 20 is canceled. This is because all of the communications permitted in the period during which the gateway 20 is set to the learning mode may not occur, in which case the communications that do not occur are not reflected in the allowed list.

Specifically, in Step S116 shown in FIG. 7, the gateway 20, which is set to the operation mode, transmits log information generated in the transfer of the packet to the log reception unit 45 of the communication management apparatus 40a. The communication management apparatus 40a performs the processing of Steps S106 to S109 shown in FIG. 6 on the received log information, and when there is a difference between the log information and the template, the communication management apparatus 40a determines whether or not to add the communication to the allowed list based on an instruction from the system management apparatus 50. By doing the above, it is possible to additionally register the communications that do not occur in the period during which the gateway 20 is set to the learning mode.

### Third Example Embodiment

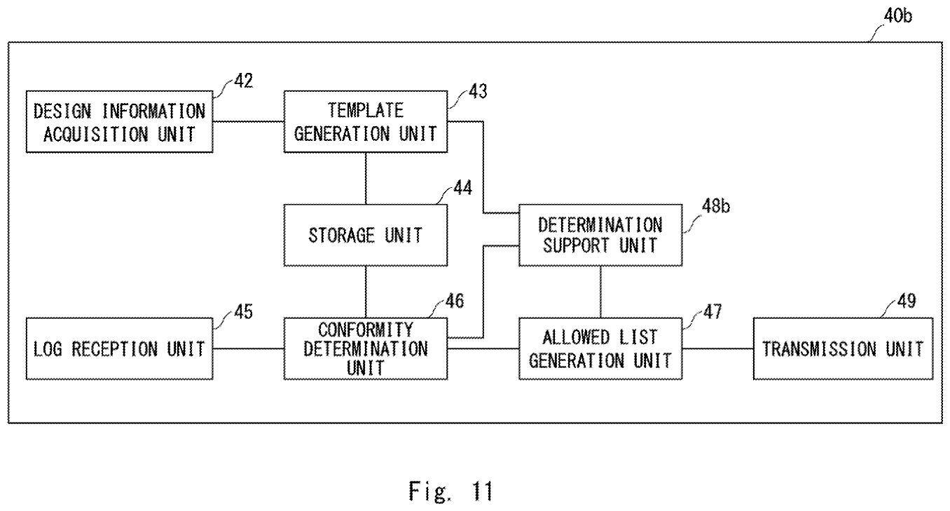

Next, a third example embodiment of the present disclosure will be described with reference to FIGS. 11 to 13. FIG. 11 is a block diagram showing an example of a configuration of a communication management apparatus 40b according to the third example embodiment. The configurations and the functions of the communication management apparatus 40b according to the third example embodiment are basically similar to those of the communication management apparatus 40a according to the second example embodiment. However, the communication management apparatus 40b differs from the communication management apparatus 40a in that the communication management apparatus 40b includes a determination support unit 48b in place of the determination support unit 48.

In addition to performing the function of the determination support unit 48, when log information does not conform to the template, the determination support unit 48b determines whether or not to generate, based on information about whether or not a template can be generated acquired from the system management apparatus 50, a template based on the log information. Then the determination support unit 48b supplies a result of the determination to the template generation unit 43. Then the template generation unit 43 generates a template from identification information of the packet related to the log information for which it is determined that a template can be generated.

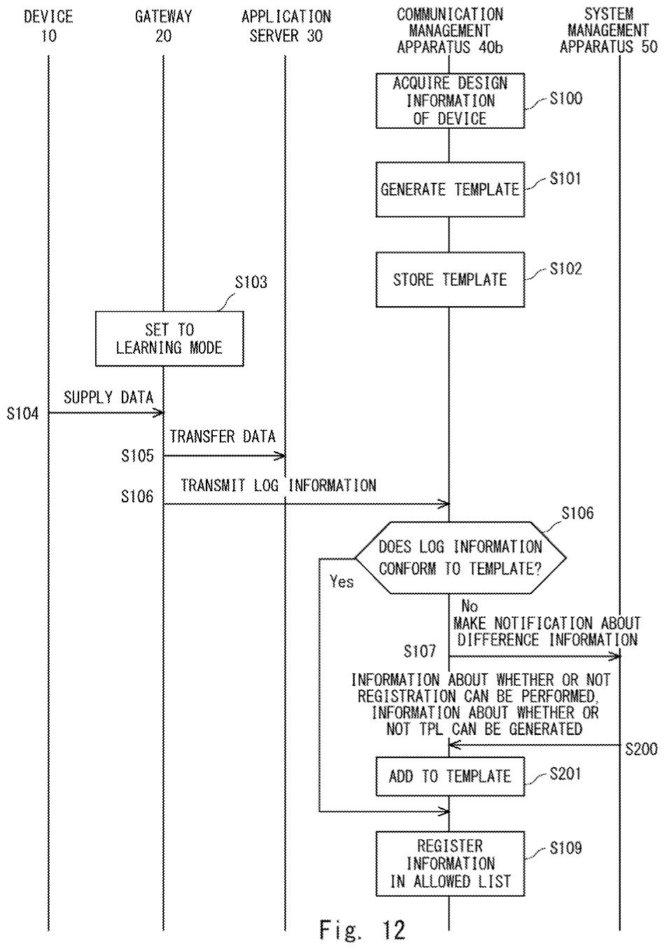

FIG. 12 is a sequence diagram showing an example of operations performed by the communication system 1 according to the third example embodiment. The processing shown in FIG. 12 includes the processing of Steps S200 and S201 instead of the processing of Step S108 shown in FIG. 6. Note that Steps similar to those shown in FIG. 6 are denoted by the same reference symbols and the descriptions thereof will be omitted.

In response to the acquisition of the difference information (Step S107), the system management apparatus 50 determines whether or not to template the identification information included in the log information. Then, in addition to the information about whether or not registration can be performed, the system management apparatus 50 transmits information about whether or not a template can be generated, which indicates a result of the determination on whether or not to generate a template, to the determination support unit 48 of the communication management apparatus 40b (Step S200). The information about whether or not a template can be generated may be information input by a system administrator, which information is determined by the system administrator based on his/her knowledge, or may be information determined based on a predetermined determination criterion.

Then the determination support unit 48 of the communication management apparatus 40b determines whether or not to generate a template based on the log information in response to the acquisition of the information about whether or not a template can be generated. Then, only when a template can be generated, the determination support unit 48 notifies the template generation unit 43 that a template can be generated and about the difference information.

Then the template generation unit 43 generates a template based on the difference information and adds the generated template to the existing templates (Step S201).

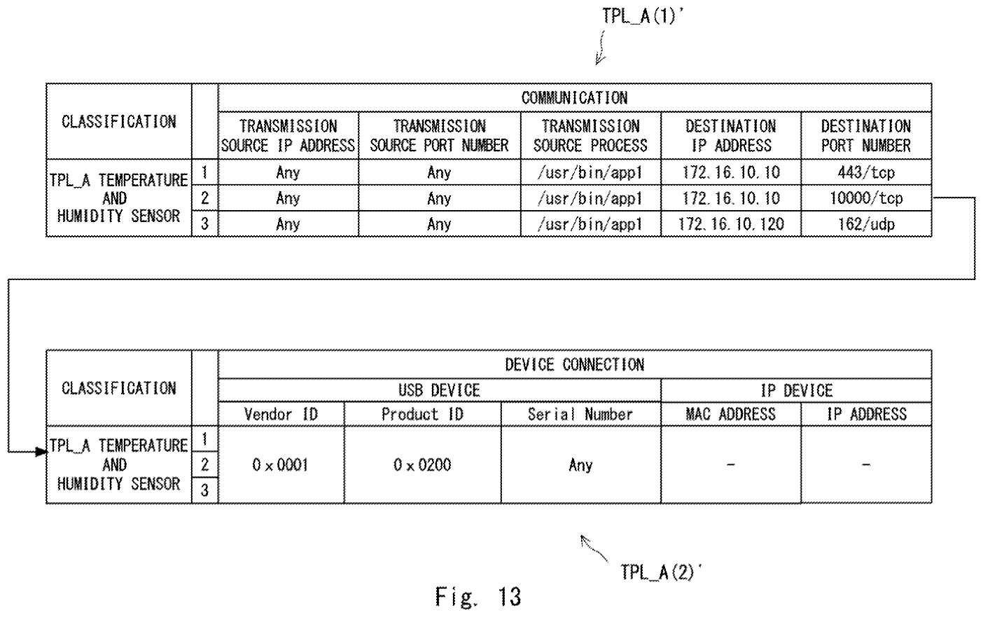

FIG. 13 is a diagram for explaining processing for adding a template performed by the communication management apparatus 40b according to third example embodiment. Templates TPL_A(1)′ and (2)′ are shown in FIG. 13. The templates TPL_A(1)′ and (2)′ are templates in which difference information shown in FIG. 10 is added to the third record of each of TPL_A(1) and (2) shown in FIG. 4.

Note that, when processing for generating an additional allowed list is performed after the learning mode of the gateway 20 is canceled, the communication management apparatus 40b may receive log information from the gateway 20 set to the operation mode and perform the processing of Steps 106 to 109, 200, and 201 shown in FIG. 12. By doing the above, it is possible to add the communications that do not occur in the period during which the gateway 20 is set to the learning mode.

As described above, according to the third example embodiment, the communication management apparatus 40b can template information related to an unknown or an unauthorized packet so that it is permanently registered in the allowed list in response to an instruction from a system administrator. Further, the generated template can also be applied to other gateways 20. Therefore, regarding a packet similar to the above packet, a system administrator does not have to transmit information about whether or not registration in the allowed list can be performed to the communication management apparatus 40b.

In the above-described example embodiments, a computer is composed of a computer system including a personal computer, a word processor, etc. However, the computer is not limited thereto and may be composed of a Local Area Network (LAN) server, a host of computer (personal computer) communications, a computer system connected on the Internet, etc. Further, functions may be distributed over respective devices on the network and the entire network may compose the computer.

Further, although the present disclosure has been described as a hardware configuration in the above example embodiments, the present disclosure is not limited thereto. In the present invention, any processing may also be implemented by causing a processor to execute a computer program.

In the above-described examples, a Central Processing Unit (CPU), a Graphics Processing Unit (GPU), a field-programmable gate array (FPGA), a digital signal processor (DSP), an application specific integrated circuit (ASIC), or the like may be used as the processor.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, DVD (Digital Versatile Disc), BD (Blu-ray (Registered Trademark) Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Processes performed by the system and the method shown in the claims, the specification, and the figures can be performed in any order as long as the order of a process is not indicated by “prior to,” “before,” or the like and as long as the output from a previous process is not used in a later process. Even if the process flow in the claims, the specification, and the figures is described using phrases such as “first” or “next” for the sake of convenience, it does not necessarily mean that the processes have to be performed in this order.

Although the present disclosure has been described with reference to the example embodiments, the present disclosure is not limited to the above-described example embodiments. Various changes that may be understood by those skilled in the art may be made to the configurations and details of the present disclosure within the scope of the invention.

### REFERENCE SIGNS LIST

1 COMMUNICATION SYSTEM
4 NETWORK
10 DEVICE
11 USB DEVICE
12 IP DEVICE
20 RELAY APPARATUS (GATEWAY)
30 APPLICATION SERVER
40, 40a, 40b COMMUNICATION MANAGEMENT APPARATUS
42 DESIGN INFORMATION ACQUISITION UNIT
43 TEMPLATE GENERATION UNIT
44 STORAGE UNIT
45 LOG RECEPTION UNIT
46 CONFORMITY DETERMINATION UNIT
47 ALLOWED LIST GENERATION UNIT
48, 48b DETERMINATION SUPPORT UNIT
49 TRANSMISSION UNIT
50 SYSTEM MANAGEMENT APPARATUS

What is claimed is:

1. A communication management apparatus provided in a communication system, the communication management apparatus comprising:
at least one memory storing program instructions; and
at least one processor configured to execute the program instructions stored in the memory to:
generate a template including identification information of a packet for transferring data supplied from a predetermined device based on design information of the communication system;
receive, from a relay apparatus configured to transfer data by a packet, log information about the transfer of the data by the packet, the data being supplied from a device provided in the communication system;
generate an allowed list based on the log information when the log information conforms to the template, a condition of a packet under which the transfer of the data by the relay apparatus is permitted being described in the allowed list;
determine, when the log information does not conform to the template, whether or not to register the identification information of the packet related to the log information in the allowed list based on information about whether or not the log information can be registered; and
transmit the generated allowed list to the relay apparatus.

2. The communication management apparatus according to claim 1, wherein in the determination of the registration about the identification information of the packet, when the log information does not conform to the template, a notification about information indicating that the log information does not conform to the template is sent to a system management apparatus, and it is determined whether or not to register the identification information of the packet related to the log information in the allowed list in response to acquisition of the information about whether or not the log information can be registered from the system management apparatus.

3. The communication management apparatus according to claim 1, wherein in the determination of the registration about the identification information of the packet, when the log information does not conform to the template, it is determined whether or not to generate, based on information about whether or not a template can be generated acquired from the system management apparatus, a template based on the log information.

4. The communication management apparatus according to claim 1, wherein the identification information of the packet includes at least one of header information of the packet, transmission source process information, and device connection information between the relay apparatus and the device.

5. The communication management apparatus according to claim 1, wherein
in the reception of log information, log information is received from each of a plurality of relay apparatuses,
in the generation of the allowed list, an allowed list for each of the plurality of relay apparatuses is generated when the received log information conforms to the template,
in the determination of the registration about the identification information of the packet, when the log information does not conform to the template, it is determined, for each of the plurality of relay apparatuses, whether or not to register the identification information of the packet related to the log information in the allowed list based on information about whether or not the log information can be registered; and
in the transmission, an allowed list corresponding to each of the plurality of relay apparatuses is transmitted to each of the plurality of relay apparatuses.

6. A communication system comprising:
a plurality of devices;
a plurality of relay apparatuses; and
a communication management apparatus, wherein
the relay apparatus transfers, by a packet, data supplied from the device provided in the communication system, and
the communication management apparatus comprises:
at least one memory storing program instructions; and
at least one processor configured to execute the program instructions stored in the memory to:
generate a template including identification information of a packet for transferring data supplied from a predetermined device based on design information of the communication system;
receive, from the relay apparatus, log information about the transfer of the data by the packet;
generate an allowed list based on the log information when the log information conforms to the template, a condition of a packet under which the transfer of the data by the relay apparatus is permitted being described in the allowed list;
determine, when the log information does not conform to the template, whether or not to register the identification information of the packet related to the log information in the allowed list based on information about whether or not the log information can be registered; and
transmit the generated allowed list to the relay apparatus.

7. The communication system according to claim 6, further comprising a system management apparatus,
wherein in the determination of the registration about the identification information of the packet, when the log information does not conform to the template, a notification about information indicating that the log information does not conform to the template is sent to the system management apparatus, and it is determined whether or not to register the identification information of the packet related to the log information in the allowed list in response to acquisition of the information about whether or not the log information can be registered from the system management apparatus.

8. A communication management method comprising:
generating a template including identification information of a packet for transferring data supplied from a predetermined device based on design information of a communication system;
receiving, from a relay apparatus configured to transfer data by a packet, log information about the transfer of the data by the packet, the data being supplied from a device provided in the communication system;
generating an allowed list based on the log information when the log information conforms to the template, a condition of a packet under which the transfer of the data by the relay apparatus is permitted being described in the allowed list;
determining, when the log information does not conform to the template, whether or not to register the identification information of the packet related to the log information in the allowed list based on information about whether or not the log information can be registered; and
transmitting the generated allowed list to the relay apparatus.

9. A non-transitory computer readable medium storing a communication management program for causing a computer to execute:
a template generation process of generating a template including identification information of a packet for transferring data supplied from a predetermined device based on design information of a communication system;
a log reception process of receiving, from a relay apparatus configured to transfer data by a packet, log information about the transfer of the data by the packet, the data being supplied from the device;
an allowed list generation process of generating an allowed list based on the log information when the log information conforms to the template, a condition of a packet under which the transfer of the data by the relay apparatus is permitted being described in the allowed list;
a determination support process of determining, when the log information does not conform to the template, whether or not to register the identification information of the packet related to the log information in the allowed list based on information about whether or not the log information can be registered; and
a transmission process of transmitting the generated allowed list to the relay apparatus.
